(19) United States
(12) Patent Application Publication
(10) Pub. No.: US 2020/0311027 A1
(43) Pub. Date: Oct. 1, 2020

(54) FILE MANAGEMENT DEVICE AND NON-TRANSITORY COMPUTER READABLE MEDIUM

(71) Applicant: FUJI XEROX CO., LTD., Tokyo (JP)

(72) Inventor: Daiki MARIYAMA, Kanagawa (JP)

(73) Assignee: FUJI XEROX CO., LTD., Tokyo (JP)

(21) Appl. No.: 16/590,457

(22) Filed: Oct. 2, 2019

(30) Foreign Application Priority Data
Apr. 1, 2019 (JP) 2019-070195

(51) Int. Cl. G06F 16/176; G06F 16/16

(52) U.S. Cl. CPC G06F 16/176; G06F 16/162

(57) ABSTRACT

A file management device includes a controller. The controller performs control to obtain a file requested by a first information processing device from a file storage and to send the requested file to the first information processing device. The controller also performs control to determine whether to delete the requested file from the file storage before an effective period of the requested file elapses. The first information processing device stores a received file in a storage and provides the file to a user.

### CROSS-REFERENCE TO RELATED APPLICATIONS

This application is based on and claims priority under 35 USC 119 from Japanese Patent Application No. 2019-070195 filed Apr. 1, 2019.

### BACKGROUND

### (i) Technical Field

The present disclosure relates to a file management device and a non-transitory computer readable medium.

### (ii) Related Art

A file management device which receives a request for a file from another device and sends the requested file to the device is known.

Japanese Unexamined Patent Application Publication No. 2009-187376 discloses a file management device which registers files to be shared among plural user terminals. The file management device includes a recorder, an extractor, a searcher, and a distributor. The recorder records the status of access to a file registered in the file management device from a user terminal in association with a feature element of the file. The extractor extracts a feature element of a file to be newly registered in the file management device. By using the feature element extracted by the extractor and that recorded by the recorder, the searcher searches among files already registered in the file management device for a file which is similar to the file to be newly registered in the file management device at a similarity degree equal to or greater than a predetermined threshold. The distributor distributes a copy of the file to be newly registered in the file management device to a specific device and instructs this device to register the copy. This specific device belongs to a domain which has accessed the registered file searched for by the searcher with a level of frequency equal to or higher than a predetermined threshold.

### SUMMARY

A file management device of the related art stores a registered file in its storage until the effective period of this file elapses, and if a file requested by a user terminal is stored in the storage, the file management device sends this file to the user terminal. In such a file management device, files received from multiple user terminals are registered in its storage. It is thus necessary to restrict the storage amount of files within the capacity of the storage.

Aspects of non-limiting embodiments of the present disclosure relate to a file management device and a non-transitory computer readable medium that can output a file requested by a user while being able to reduce the storage amount of files in a storage compared with a configuration in which files are kept in the storage during the effective periods of the files.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a file management device including a controller. The controller performs control to obtain a file requested by a first information processing device from a file storage and to send the requested file to the first information processing device. The controller also performs control to determine whether to delete the requested file from the file storage before an effective period of the requested file elapses. The first information processing device stores a received file in a storage and provides the file to a user.

### BRIEF DESCRIPTION OF THE DRAWINGS

An exemplary embodiment of the present disclosure will be described in detail based on the following figures, wherein:

FIG. 1 is a schematic diagram illustrating an example of the configuration of a file management system;

FIG. 2 is a sequence diagram illustrating an example of a flow of information in the file management system;

FIG. 3 is a block diagram illustrating an example of the functional configuration of a user terminal;

FIG. 4 is a block diagram illustrating an example of the functional configuration of a file management device;

FIG. 5 illustrates an example of a file management table;

FIG. 6 illustrates an example of a record table;

FIG. 7 is a block diagram illustrating an example of the functional configuration of an output device;

FIG. 8 illustrates an example of a file table;

FIG. 9 illustrates examples of the major elements of the electrical system configuration of each of the user terminal and the file management device;

FIG. 10 illustrates examples of the major elements of the electrical system configuration of the output device;

FIG. 11 is a flowchart illustrating an example of distribution processing executed by the file management device;

FIG. 12 is a flowchart illustrating an example of use mode determining processing;

FIG. 13 is a flowchart illustrating an example of file output processing executed by the output device;

FIG. 14 is a flowchart illustrating an example of regular processing executed by the file management device;

FIG. 15 is a flowchart illustrating a modified example of distribution processing executed by the file management device; and

FIG. 16 is a flowchart illustrating a modified example of regular processing executed by the file management device.

### DETAILED DESCRIPTION

An exemplary embodiment of the disclosure will be described below with reference to the accompanying drawings. Elements having the same functions are designated by like reference numeral in the drawings and an explanation thereof will not be repeated. The same operation is designated by like step number in the drawings and an explanation thereof will not be repeated.

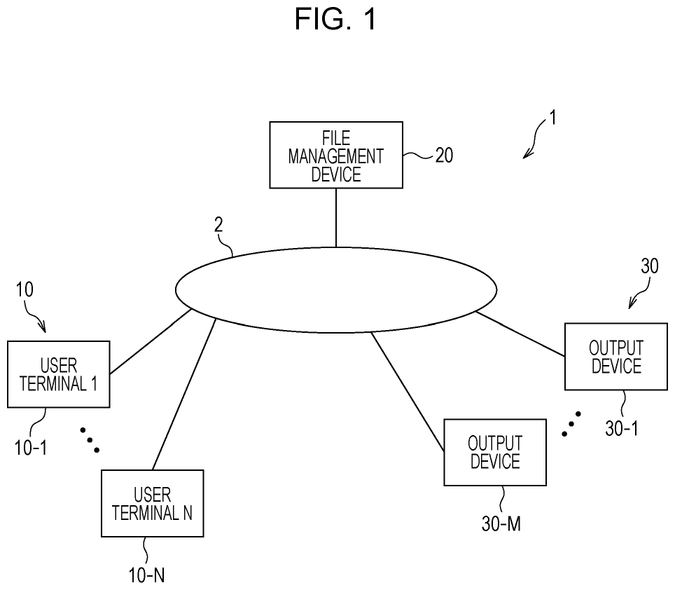

FIG. 1 is a schematic diagram illustrating an example of the configuration of a file management system 1 according to the exemplary embodiment. The file management system 1 includes a user terminal 10, a file management device 20, and an output device 30 that are each connected to a communication network 2.

The communication network 2 in the file management system 1 may be a wired network, a wireless network, or a wired-and-wireless network. The communication network 2 may be a private network, or may alternatively be a public network, such as the Internet, shared by many and unspecified users.

The user terminal 10 is a device used by a user to register a file in the file management device 20 (such a user will be called a register user). The user terminal 10 is also used by a user to output a file registered in the file management device 20 by using the output device 30 (such a user will be called an output user). As the user terminal 10, an information device having an input/output function of providing an interface with a user, a processing function of processing information, and a communication function of performing data communication via the communication network 2 is used. Examples of such an information device are a desktop computer, a tablet computer, a smartphone, and a wearable terminal. Users using the file management system 1 including register users and output users will collectively and simply be called users.

“File” used in this exemplary embodiment refers to a set of items of data generated based on a predetermined format and representing a certain type of information as a whole. The content of a file is not restricted to a particular type and may include information represented in various modes, such as an image, video, sound, and a document.

The number of user terminals 10 included in the file management system 1 is not limited to a particular number, and N (N is an integer of one or greater) user terminals 10 are connected to the communication network 2. User terminals 10 are individually designated by user terminals 10-1 through 10-N, as shown in FIG. 1. However, if it is not necessary to distinguish the user terminals 10-1 through 10-N from each other, they will collectively be designated by the user terminal 10 or user terminals 10. One user may own plural user terminals 10.

The file management device 20 stores a file received from a register user in a file storage. When an output user sends a request to output a file stored in the file management device 20 by using the output device 30, the file management device 20 sends this file to the output device 30.

Storing a file received from a register user in the file storage so that an output user can receive this file by using the output device 30 is called “registering a file”.

As the file management device 20, as well as in the user terminal 10, an information device having an input/output function of providing an interface with an administrator of the file management device 20, a processing function of processing information, and a communication function of performing data communication via the communication network 2 is used. The file management device 20 is required to process requests from plural user terminals 10 and plural output devices 30. A computer, such as a server or a workstation, which offers higher information processing performance than the user terminal 10, is thus used as the file management device 20.

Operations executed by the file management device 20, which is required to process a larger amount of information than the user terminal 10, may be distributed among plural computers. For the sake of description, however, it is assumed that the file management device 20 is constructed as a single computer. The file management device 20 may alternatively be constructed by using cloud computing services.

The output device 30 is a device installed in a specific location, such as a public facility, a company, or a store. The output device 30 may be installed in any location. It is however assumed in this exemplary embodiment that the output device 30 is installed in a store, such as a convenience store, where many and unspecified users can enter without any permission.

As in the user terminal 10, the number of output devices 30 included in the file management system 1 is not limited to a particular number, and M (M is an integer of one or greater) output devices 30 are connected to the communication network 2. Output devices 30 are individually designated by output devices 30-1 through 30-M, as shown in FIG. 1. However, if it is not necessary to distinguish the output devices 30-1 through 30-M from each other, they will collectively be designated by the output device 30 or output devices 30.

The output device 30 outputs a file requested by an output user in collaboration with the file management device 20. “Outputting a file” refers to making information included in a file recognizable. The subject that recognizes the content of information is not limited to an output user and may alternatively be an information device. A file may be output in various modes. For example, information included in a file may be displayed on a display, printed on a recording medium, such as a sheet, output as sound, and stored in a storage medium. A file may also be transferred to an external device via the communication network 2.

In the following description, it is assumed that a file is output as a result of the output device 30 printing an image included in the file on a recording medium. The output device 30 is an example of an information processing device in the exemplary embodiment.

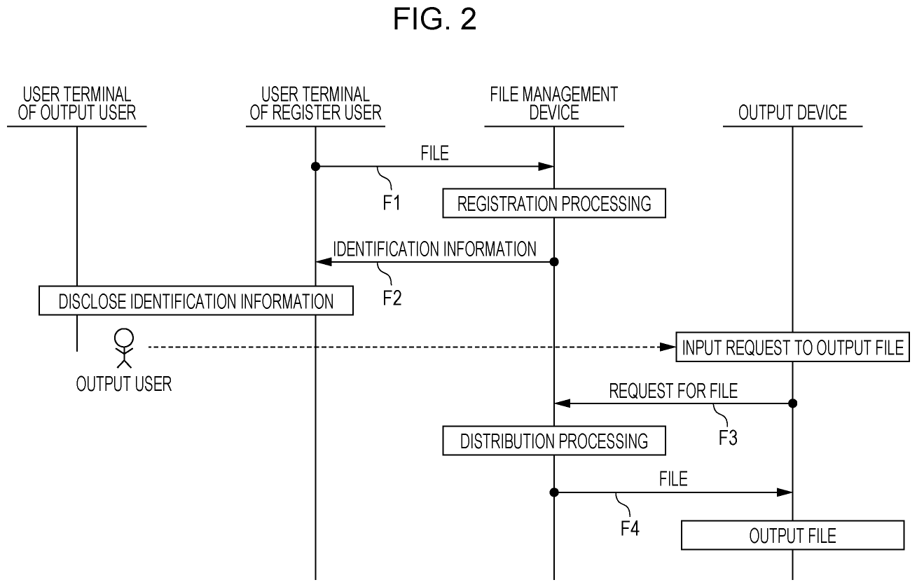

FIG. 2 is a sequence diagram illustrating an example of a flow of information in the file management system 1 which provides a file providing service. The file providing service provided by the file management system 1 will be described below with reference to FIG. 2.

In F1 in FIG. 2, a register user operates its user terminal 10 to send a file to the file management device 20. As discussed above, a file may have any type of content. If, for example, the output device 30 prints the content of a file on a recording medium, print data indicating a book jacket or a paper model created by the register user as a file may be sent to the file management device 20.

Upon receiving the file from the register user, the file management device 20 executes registration processing for registering the received file. More specifically, in F2 in FIG. 2, the file management device 20 generates identification information associated with the file and sends the identification information to the user terminal 10 of the register user to inform it that the file has been registered.

Identification information is an identifier uniquely associated with a file. By referring to identification information, a specific file associated with this identification information can be selected from among plural files registered in the file management device 20. The file identified from the identification information is the file associated with this identification information.

The register user discloses the identification information received from the file management device 20, together with overview information indicating an overview of the content of the file, by using an information sharing medium, such as a social networking service (SNS). This makes it possible for other users to understand what type of content the file registered by the register user in the file management device 20 has and enables the register user to get the other users interested in using the file. Hereinafter, identification information and overview information concerning a file associated with the identification information may simply be called identification information and other information.

The file management device 20 does not have a function of sending a file registered by a register user to the user terminal 10 of another user. If another user becomes interested in the content of the file and wishes to output it, the user goes to a store where the output device 30 is installed and inputs a request to output the file together with the associated identification information.

Then, in F3 in FIG. 2, the output device 30 sends a request to send the file to the file management device 20. The file management device 20 executes distribution processing for selecting the file associated with the received identification information among the registered files and distributing the selected file. In F4 in FIG. 2, when the file management device 20 has sent the file to the output device 30 as a result of executing distribution processing, the output device 30 prints the image in the received file on a recording medium so as to output the image to the output user.

To output files from the output device 30, some files are free of charge, and some files are charged. If an output user outputs a charged file by using the output device 30, it pays a certain fee charged for this file. Data concerning paid fees is managed in the file management device 20 for each file, and the cumulative amount of money based on the number of times the file is output is input into a bank account, for example, of the register user having registered this file.

The effective period is set for each file registered in the file management device 20. When the effective period of a certain file has elapsed, the file management device 20 deletes this file from the file storage so as to maintain a sufficient space in the file storage. In the sequence diagram in FIG. 2, the output user makes a request to output the file by using the output device 30 before the effective period of the file has elapsed.

In FIG. 2, the register user having registered the file in the file management device 20 and the output user having made a request to output the file are different users. This type of file use mode is called a joint use mode or a shared use mode.

In contrast, there may be a case in which a register user and an output user are the same user. For example, a register user registers a file for personal use, such as a resume, in the file management device 20 and outputs the file by using an output device 30 in a nearby store. This type of file use mode is called a personal use mode.

A file for personal use is a file personally used by a register user, and the register user does not disclose identification information concerning this file on an SNS.

In this manner, a register user may register, not only a file for joint use, but also a file for personal use in the file management device 20.

If a registered file is for joint use, it is likely that multiple output users will each make a request for this file by using the output device 30 installed in a store within the living area of the user. It is thus desirable to store such a file in the file management device 20.

If a registered file is for personal use, the file management device 20 receives a request for this file always from the same output user (that is, the same register user). In this case, this user is likely to use the same output device 30 in the same store within its living area for many times. That is, if an output user outputs a file for personal use by using the same output device 30 for many times, it will take less time to output the file if the file is stored in the output device 30 used by the user rather than being stored in the file management device 20. This also eliminates the need for the file management device 20 to send the file to the output device 30 every time a request for this file is received.

Hence, if a file is found to be for an output user for personal use, the file management device 20 deletes this file before the effective period of this file elapses and also stores the file in the output device 30 used by the output user. If a file is found to be for joint use, the file management device 20 stores this file in the file storage of the file management device 20 instead of in the output device 30.

In this manner, the file management system 1 switches the storage location of a file depending on its use mode. The functional configuration of each device included in the file management system 1 will be described below.

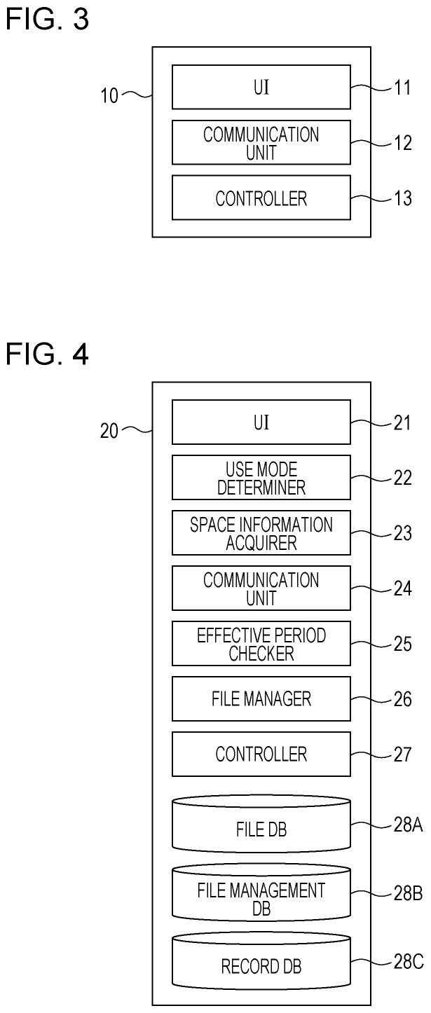

FIG. 3 is a block diagram illustrating an example of the functional configuration of the user terminal 10. As shown in FIG. 3, the user terminal 10 includes a user interface (UI) 11, a communication unit 12, and a controller 13.

The UI 11 receives an instruction from a user and also supplies various items of information, such as a response returned from the file management device 20, to a user. More specifically, the UI 11 receives an instruction to register a file from a register user and informs the register user of identification information concerning the file registered in the file management device 20. The UI 11 also receives an instruction to post identification information and other information concerning a file on an SNS from a register user to use the file in the joint use mode, and also informs an output user who has accessed the SNS of identification information and other information posted by a register user.

The communication unit 12 sends and receives via the communication network 2 various items of information to and from the other devices included in the file management system 1 and devices outside the file management system 1. Devices outside the file management system 1 will be called external devices.

The controller 13 controls the user terminal 10 in accordance with an instruction received from the UI 11 and various items of information received from the communication unit 12 so that the user terminal 10 can execute corresponding processing.

FIG. 4 is a block diagram illustrating an example of the functional configuration of the file management device 20. As shown in FIG. 4, the file management device 20 includes, as functions, a UI 21, a use mode determiner 22, a space information acquirer 23, a communication unit 24, an effective period checker 25, a file manager 26, and a controller 27. The file management device 20 also includes a file database (DB) 28A, a file management DB 28B, and a record DB 28C.

The UI 21 provides an interface for receiving an instruction from an administrator operating the file management device 20. The UI 21 also supplies information concerning the registration and distribution situations of files in the file management device 20 to the administrator.

The use mode determiner 22 determines whether a file registered by a register user is for personal use or for joint use.

The space information acquirer 23 obtains information concerning the space of the storage of each output device 30 included in the file management system 1 so as to monitor the situations of the use of the storages. That is, the space information acquirer 23 is an example of an acquirer according to the exemplary embodiment.

The communication unit 24 sends and receives via the communication network 2 various items of information to and from the other devices included in the file management system 1 and external devices.

The effective period checker 25 checks the effective period of each file stored in the file storage at regular intervals and informs the controller 27 of an expired file.

The file manager 26 stores and deletes files in and from the file storage and also updates file management information and record information. The file management information is used for managing files.

The controller 27 controls the above-described functions of the file management device 20 in accordance with an instruction from the administrator and the content of information received via the communication network 2 so that the file management device 20 can suitably execute processing in accordance with the situation. If the controller 27 receives information about an expired file from the effective period checker 25, it deletes this expired file.

The file DB 28A is a storage mechanism constructed in the file storage. The file storage is used in the file management device 20 to store files registered by register users. The file manager 26 stores and deletes files in and from the file DB 28A under the control of the controller 27.

The file management DB 28B is a storage mechanism constructed in the file storage, for example. The file management DB 28B stores a file management table 4 for managing files registered in the file management device 20.

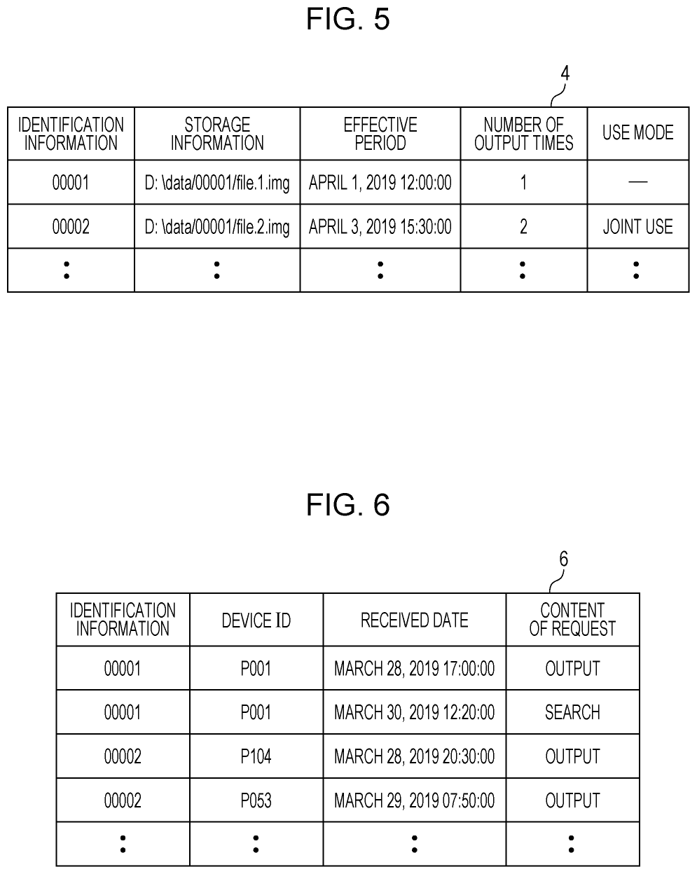

FIG. 5 illustrates an example of the file management table 4 managed in the file management DB 28B.

The file management table 4 is a table for storing file management information concerning each file registered in the file management device 20. In the file management table 4, identification information, storage information, effective period, the number of output times, and use mode are set for each file.

As the identification information, identification information associated with a file is set. Identification information may be represented in any format if the associated registered file is uniquely identifiable from this identification information, as discussed above. In FIG. 5, the identification information is represented by five-digit numerical numbers.

As the storage information, the storage location of a registered file is recorded together with the file name. The file manager 26 checks the storage location represented by the storage information and stores or deletes a file in or from the file DB 28A.

As the effective period in the file management information, a preset effective period of a file is stored. As the effective period, the time one week after a file is received from the user terminal 10, for example, is set. In the example in FIG. 5, the actual date and time is stored as the effective period. The effective period may be changeable by the administrator of the file management device 20. Different effective periods may be set according to the type of file or the register user. The effective period checker 25 checks the effective period of each file represented by the file management information and judges whether the file has expired.

As the number of output times in the file management information, the cumulative number of output times that a file has been output by using the output devices 30 within the effective period of the file is stored.

As the use mode in the file management information, the file use mode determined by the use mode determiner 22 is set. The controller 27 checks the use mode of a file represented by the file management information and performs control to switch the storage location of the file.

The items of information included in the file management information managed by the file management table 4 in FIG. 5 are only examples. Another item of information, such as a user identification (ID) assigned to each register user may be set in the file management information to uniquely identify a register user having registered a file.

Referring back to FIG. 4, the record DB 28C is a storage mechanism constructed in the file storage, for example. The record DB 28C stores a request record of output users for a registered file.

FIG. 6 illustrates an example of a record table 6 stored in the record DB 28C.

The record table 6 is a table for storing record information for each request. The record information indicates the content of a request for a file made by an output user by using an output device 30. In the record table 6, identification information, a device ID, a received date, and the content of a request are set for each request.

As the identification information, identification information concerning a file requested by an output user is stored.

As the device ID in the record information, the device ID of an output device 30 operated by an output user is stored. The device ID is assigned to each output device 30 so that the output device 30 can uniquely be identified. When an output user has made a request for a file by using an output device 30, the controller 27 stores the device ID supplied from the output device 30 in the device ID field of the record information.

As the received date in the record information, the date and time on and at which a request for a file is received from an output device 30 is set.

As the content of a request in the record information, the content of a request for a file received from an output device 30 is set. The content of a request for a file is the type of request. The type of request is different according to the content of operation performed by an output user using an output device 30. Examples of the content of a request are “output”, that is, a request to output a selected file with an output device 30, “search”, that is, a request to search for a certain file among files registered in the file management device 20, and “query”, that is, a request to make a query about the content of a selected file.

In this manner, the content of operation performed by an output user by using an output device 30 is reflected in the content of a request in the record information. The content of a request is an example of an operation record in the exemplary embodiment. Every time an output user makes a request for a file, the file manager 26 writes record information in the record table 6. The items of information included in the record information managed by the record table 6 in FIG. 6 are only examples. Another item of information may be set in the record information.

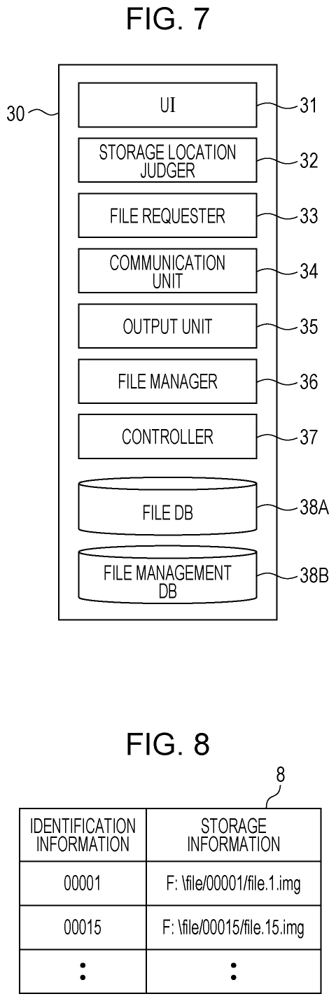

FIG. 7 is a block diagram illustrating an example of the functional configuration of the output device 30. As shown in FIG. 7, the output device 30 includes, as functions, a UI 31, a storage location judger 32, a file requester 33, a communication unit 34, an output unit 35, a file manager 36, and a controller 37. The output device 30 also includes a file DB 38A and a file management DB 38B.

The UI 31 provides an interface for receiving an instruction from an output user operating the output device 30. The UI 31 also supplies information concerning the content of a request made by an output user.

Upon receiving a file from the file management device 20, the storage location judger 32 judges whether to store the file in the file DB 38A of the output device 30.

If the content of a request for a file made by an output user concerns the outputting of the file and if the storage location judger 32 has found that the file is currently stored in the file management device 20, the file requester 33 requests the file management device 20 to send the file. Hereinafter, a file requested by an output user may simply be called a requested file.

The communication unit 34 sends and receives via the communication network 2 various items of information to and from the other devices included in the file management system 1 and external devices. More specifically, the communication unit 34 sends a request for a file made by an output user to the file management device 20 and also receives the file sent from the file management device 20.

The output unit 35 outputs a file requested by an output user. In this exemplary embodiment, the output unit 35 prints an image represented by the file on a recording medium.

The file manager 36 stores and deletes files and also accordingly updates file information used for managing files.

The controller 37 controls the above-described functions of the output device 30 in accordance with an instruction from an output user and the content of information received via the communication network 2 so that the output device 30 can suitably execute processing in accordance with the situation.

The file DB 38A is a storage mechanism constructed in the storage of the output device 30. In the file DB 38A, files determined to be stored in the output device 30 by the storage location judger 32 are stored. The file manager 36 stores and deletes files in and from the file DB 38A under the control of the controller 37.

The file management DB 38B is a storage mechanism constructed in the storage of the output device 30, for example. The file management DB 38B stores file information concerning files stored in the file DB 38A.

FIG. 8 illustrates an example of a file table 8 managed by the file management DB 38B. In the file table 8, file information concerning a file stored in the file DB 38A is stored for each file. In the file table 8, identification information and storage information, for example, are set.

As the identification information, identification information concerning a file stored in the file DB 38A is stored.

As the storage information, the storage location of a file stored in the file DB 38A is recorded together with the file name. The file manager 36 checks the storage location represented by the storage information and stores or deletes a file in or from the file DB 38A.

The items of information included in the file information managed by the file table 8 in FIG. 8 are only examples. Another item of information, such as the date on which a file is stored in the file DB 38A, may be set in the file information.

Examples of the major elements of the electrical system configuration of each device included in the file management system 1 will now be described below.

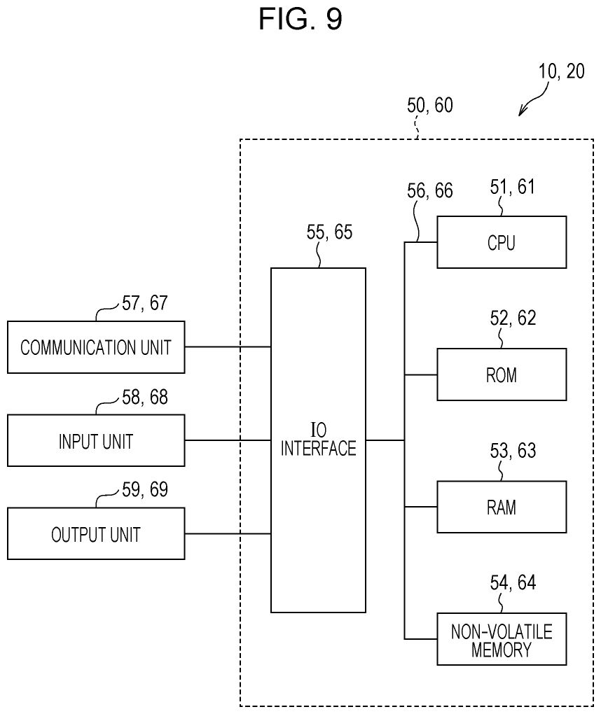

FIG. 9 illustrates examples of the major elements of the electrical system configuration of the user terminal 10. As discussed above, the user terminal 10 is constituted by a computer, such as a computer 50.

The computer 50 includes a central processing unit (CPU) 51, a read only memory (ROM) 52, a random access memory (RAM) 53, a non-volatile memory 54, and an input/output (IO) interface 55. The CPU 51 implements the individual functions of the user terminal 10 shown in FIG. 3. The ROM 52 stores a user terminal program for causing the computer 50 to serve as the individual functions shown in FIG. 3. The RAM 53 is used as a temporary work area for the CPU 51. The CPU 51, the ROM 52, the RAM 53, the non-volatile memory 54, and the IO interface 55 are connected to one another via a bus 56.

The non-volatile memory 54 is an example of a storage that can retrieve stored information even after power supplied to the non-volatile memory 54 is interrupted. As the non-volatile memory 54, a semiconductor memory, for example, is used, or a hard disk may alternatively be used. The non-volatile memory 54 may not necessarily be contained in the computer 50, and may be a portable storage, such as a memory card, attached to and detached from the computer 50.

A communication unit 57, an input unit 58, and an output unit 59, for example, are connected to the IO interface 55.

The communication unit 57 is connected to the communication network 2 and has a communication protocol for performing data communication with the devices connected to the network 2.

The input unit 58 is a device that receives an instruction from a user and supplies this instruction to the CPU 51. Examples of the input unit 58 are buttons, a touchscreen, and a keyboard and a mouse.

The output unit 59 is a device that outputs information processed by the CPU 51. Examples of the output unit 59 are a liquid crystal display, an organic electroluminescence (EL) display, and a projector projecting an image on a screen.

Examples of the major elements of the electrical system configuration of the file management device 20 are the same as those of the user terminal 10 shown in FIG. 9. The file management device 20 is constituted by a computer 60.

The file management device 20 includes a CPU 61, a ROM 62, a RAM 63, a non-volatile memory 64, an IO interface 65, a bus 66, a communication unit 67, an input unit 68, and an output unit 69 instead of the CPU 51, the ROM 52, the RAM 53, the non-volatile memory 54, the IO interface 55, the bus 56, the communication unit 57, the input unit 58, and the output unit 59, respectively, of the user terminal 10.

The CPU 61 implements the individual functions of the file management device 20 shown in FIG. 4. The ROM 62 stores a file management program for causing the computer 60 to serve as the individual functions shown in FIG. 4. The RAM 63 is used as a temporary work area for the CPU 61.

The input unit 68 of the file management device 20 receives an instruction from the administrator of the file management device 20 instead of from a user.

In the non-volatile memory 64, the file DB 28A, the file management DB 28B, and the record DB 28C, for example, are constructed.

In addition to or instead of the units connected to the IO interface 55 of the user terminal 10 and those to the IO interface 65 of the file management device 20 shown in FIG. 9, another unit may be connected.

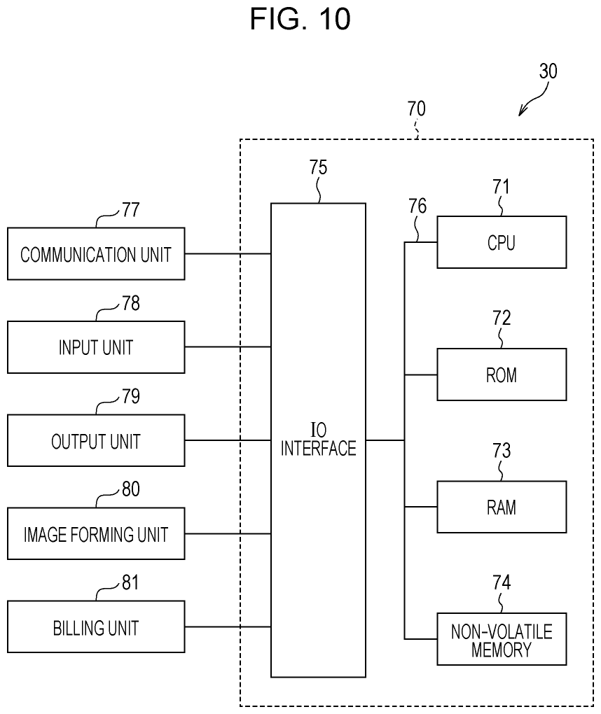

FIG. 10 illustrates examples of the major elements of the electrical system configuration of the output device 30. The output device 30 is constituted by a computer 70, for example.

The computer 70 includes a CPU 71, a ROM 72, a RAM 73, a non-volatile memory 74, and an IO interface 75. The CPU 71 implements the individual functions of the output device 30 shown in FIG. 7. The ROM 72 stores an information processing program for causing the computer 70 to serve as the individual functions shown in FIG. 7. The RAM 73 is used as a temporary work area for the CPU 71. The CPU 71, the ROM 72, the RAM 73, the non-volatile memory 74, and the IO interface 75 are connected to one another via a bus 76.

In the non-volatile memory 74, the file DB 38A and the file management DB 38B, for example, are constructed.

A communication unit 77, an input unit 78, an output unit 79, an image forming unit 80, and a billing unit 81, for example, are connected to the IO interface 75.

The communication unit 77 is connected to the communication network 2 and has a communication protocol for performing data communication with the devices connected to the network 2.

The input unit 78 is a device that receives an instruction from an output user and supplies this instruction to the CPU 71. Examples of the input unit 78 are buttons and a touchscreen. If an output user gives an instruction with voice, a microphone may be used as the input unit 78. Input/output devices that input and output data, such as a card slot and a universal serial bus (USB) port for reading and writing data from and into a memory card, are also examples of the input unit 78.

The output unit 79 is a device that outputs information processed by the CPU 71. Examples of the output unit 79 are a liquid crystal display and an organic EL display. If information is output with voice, a speaker may be used as the output unit 79.

The image forming unit 80 is a unit that prints the content of a file on a recording medium in accordance with an instruction from the CPU 71. Any printing method, such as the electrophotographic system or the inkjet method, may be used in the image forming unit 80.

The billing unit 81 is a device that collects a fee from an output user and informs the CPU 71 that a payment is made if a file output from the output device 30 is a charged file. The billing unit 81 supports at least one of the payment methods using electronic money, credit cards, electronic billing with barcodes, cash, and prepaid cards.

Units connected to the IO interface 75 of the output device 30 are not restricted to those shown in FIG. 10. A required unit is connected to the IO interface 75 in accordance with the output method of files in the output device 30. To provide various services concerning files, the output device 30 may have multiple functions regarding images, such as a fax function, a scan function, and a copy function, in addition to the image forming function using the image forming unit 80.

If the output device 30 has a fax function, a fax communication unit that performs fax communication with other fax machines via a fax line is connected to the IO interface 75. If the output device 30 has a scan function, a scanning unit is connected to the IO interface 75. The scanning unit optically reads the content of a document placed on platen glass, for example, and converts the read content into image data in accordance with an instruction from the CPU 71. If the output device 30 has a copy function, the above-described scanning unit is connected to the IO interface 75. The CPU 71 causes the scanning unit to read image data indicating a document and the image forming unit 80 to print the read image data on a recording medium.

The operation of the file management device 20 will be described below in detail.

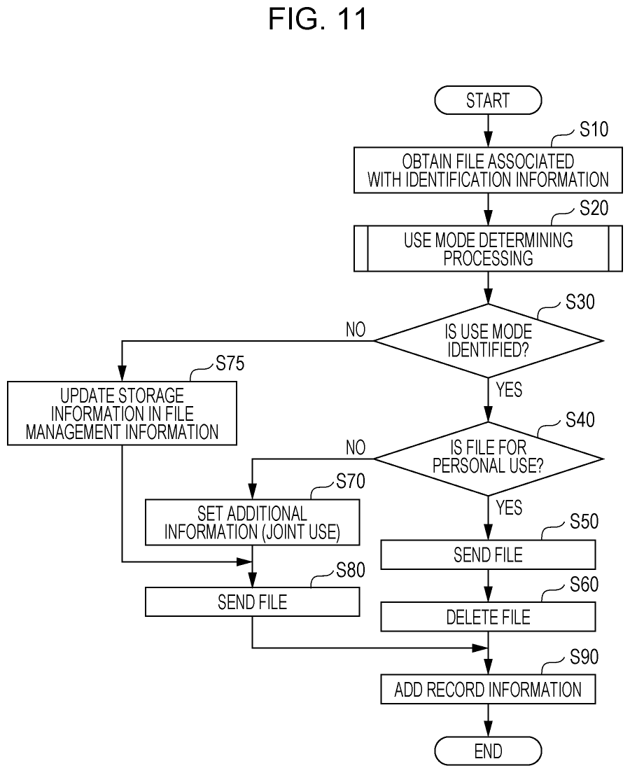

FIG. 11 is a flowchart illustrating an example of distribution processing executed by the CPU 61 of the file management device 20 upon receiving a request for a file from an output device 30. The file management program which defines distribution processing is stored in advance in the ROM 62 of the file management device 20, for example. The CPU 61 reads the file management program stored in the ROM 62 and executes distribution processing.

It is assumed that the file DB 28A of the file management device 20 stores a file requested by the output device 30.

In step S10, the CPU 61 refers to the file management table 4 and obtains the file management information indicating identification information described in the request from the output device 30. Then, the CPU 61 refers to the storage information in the file management information and reads the file associated with the identification information from the non-volatile memory 64.

In step S20, the CPU 61 executes use mode determining processing for determining the use mode of the file associated with the identification information described in the request, that is, the use mode of the requested file. Details of use mode determining processing will be discussed later.

In step S30, the CPU 61 judges whether the use mode of the requested file is identified as a result of executing use mode determining processing in step S20.

If the use mode of the requested file is identified, the process proceeds to step S40. In step S40, the CPU 61 judges from the identified use mode whether the requested file is for personal use. If the requested file is for personal use, the process proceeds to step S50.

In step S50, the CPU 61 sends the requested file appended with additional information indicating the file use mode (in this case, personal use mode) to the output device 30 which has sent the request. As a result of the output device 30 receiving the requested file appended with additional information indicating that the requested file is for personal use, the requested file can be stored in the output device 30. This will be discussed in detail later. As discussed above, if the requested file is for personal use, a request to output this file is likely to be made again from the same output device 30 used for the previous request for this file. That is, it is more efficient if the file is managed in the output device 30 rather than in the file management device 20, thereby eliminating the need for the file management device 20 to send the same file to the same output device 30.

In step S60, the CPU 61 deletes the requested file sent to the output device 30 from the file DB 28A and also updates the file management information concerning the requested file. More specifically, in order to show which storage device 30 stores the requested file, the CPU 61 deletes the storage location of this file in the file management device 20 from the storage information field of the file management information, and sets the new storage location of the requested file, such as a uniform resource locator (URL) of the output device 30. The CPU 61 also increments the number of output times by one described in the file management information concerning the requested file. That is, although the CPU 61 deletes the requested file from the file DB 28A, it does not erase the file management information concerning this file.

As a result of having accepted the request concerning the file from the output device 30, in step S90, the CPU 61 creates record information including the items of information shown in FIG. 6 for the requested file and adds this record information to the record table 6. As the identification information in the record information, the identification information described in the request is stored. As the device ID, the device ID of the output device 30 also described in the request is stored. As the received date, the date and time on and at which the request is received by the communication unit 67 is stored. As the content of the request, “output” is set since a request to output the file is received from the output device 30.

The CPU 61 obtains date information by using a calendar function built in the CPU 61, for example, and sets the received date in the record information. The CPU 61 may alternatively obtain date information from a time server, which is an example of an external device connected to the communication network 2. The CPU 61 then completes distribution processing in FIG. 11.

If it is found in step S40 based on the result of use mode determining processing that the requested file is not for personal use, that is, the requested file is for joint use, the process proceeds to step S70.

In step S70, the CPU 61 appends additional information indicating that the requested file is for joint use to the requested file.

In step S80, the CPU 61 sends the requested file appended with additional information indicating that the file is for joint use, which is set in step S70, to the output device 30. The CPU 61 also increments the number of output times by one in the file management information concerning this requested file. In step S90, the CPU 61 adds record information concerning the requested file to the record table 6 and then completes distribution processing in FIG. 11.

As discussed above, if the requested file is for joint use, it is more likely that a request for the file will be received again from another output device 30 other than the output device 30 that has sent the previous request. If, as in a file for personal use, the file is deleted from the file DB 28A after having been sent to the output device 30, the file management device 20 is required to obtain the file from the output device 30 storing this file every time a request for the file is received. To avoid such a situation, the CPU 61 does not delete the file.

If it is found in step S30 that the use mode of the requested file is not identified after use mode determining processing in step S20, the process proceeds to step S75.

In step S75, in the storage information field of the file management information obtained in step S10, the CPU 61 stores information indicating the URL of the output device 30, for example, in addition to the storage location of the file in the file management device 20.

In step S80, the CPU 61 sends the requested file without additional information concerning the file use mode to the output device 30. The CPU 61 then increments the number of output times by one in the file management information concerning the requested file. In step S90, the CPU 61 adds record information concerning this file to the record table 6 and then completes distribution processing in FIG. 11.

If the use mode of the requested file is not identified, there is a possibility that the file is for joint use, and the CPU 61 does not delete the requested file from the file DB 28A. Upon receiving the requested file without additional information concerning the use mode, the requested file can be stored in the output device 30. This will be discussed in detail later.

Regardless of whether a file is for personal use or for joint use, the CPU 61 deletes an expired file from the file DB 28A and also erases the file management information concerning the deleted file from the file management table 4.

If an expired file is stored in the output device 30, the CPU 61 sends a file deletion request including identification information associated with the expired file to the output device 30 so as to instruct it to delete the file.

Use mode determining processing in step S20 will be explained below in detail.

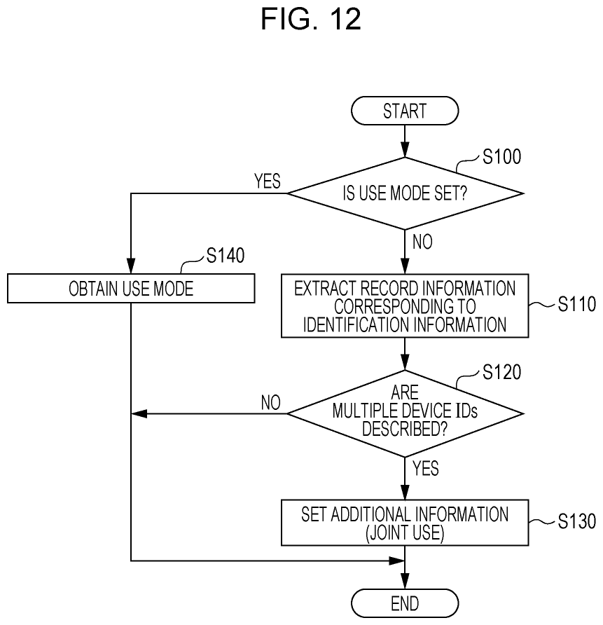

FIG. 12 is a flowchart illustrating an example of use mode determining processing executed in step S20.

When registering a file in the file management device 20, a register user may also set the use mode of the file so as to clarify how the file will be used. Upon receiving a file from a register user, the CPU 61 executes the following registration processing. The CPU 61 generates identification information associated with the received file and stores the file in the file DB 28A. The CPU 61 also generates file management information concerning the received file and adds it to the file management table 4. If the use mode is set in the received file, the CPU 61 stores this file use mode in the use mode field of the file management information.

In contrast, there may be a case in which the use mode is not set in a received file. In this case, the CPU 61 writes a predetermined symbol representing that no use mode is set into the use mode field of the file management information. In the example of the file management information shown in FIG. 5, a dash (line) is stored to represent that no use mode is set.

When an output user makes a request for a file by using an output device 30 for the first time, it may set the use mode of the file in the first request so as to clarify how the file will be used. Upon receiving the request from the output device 30, the CPU 61 checks for the use mode described in the request. If the use mode is described in the request, the CPU 61 writes this use mode in the use mode field of the file management information indicating the identification information also described in the request.

An output user does not always set the use mode of a file in the first request and may do so in the second or subsequent request.

If it is found from the record table 6 that a request for a file received from an output device 30 is the first request, the CPU 61 may refer to the use mode field of the file management information obtained in step S10 and judge whether the use mode is set in the requested file. Instead, in step S100 in use mode determining processing, every time a request for a file is received from an output device 30, the CPU 61 refers to the use mode field of the file management information obtained in step S10 and judges whether the use mode is set in the requested file. If the use mode is set, the process proceeds to step S140.

In step S140, the CPU 61 obtains the use mode indicated in the file management information obtained in step S10 and determines it as the use mode of the requested file. The CPU 61 then completes use mode determining processing in FIG. 12.

If it is found in step S100 that the use mode is not set in the file management information, the process proceeds to step S110.

If the requested file is for joint use, plural output users may have operated their output devices 30 to individually make a request for this file. Checking record information concerning this file may thus be able to identify the use mode of the requested file.

In step S110, the CPU 61 extracts record information indicating the identification information concerning the requested file from the record DB 28C.

If the extracted record information indicates that requests for the file have been made from different output devices 30, the file is likely to be for joint use. In step S120, the CPU 61 judges whether multiple device IDs are described in the extracted record information. If multiple device IDs are described, the process proceeds to step S130.

If multiple device IDs are described in the extracted record information, it means that plural output users have made requests for this file. In step S130, the CPU 61 thus appends additional information indicating that the requested file is for joint use to the requested file. The CPU 61 then completes use mode determining processing in FIG. 12.

If the extracted record information indicates that only the single device ID is described, the CPU 61 may determine that the requested file is for personal use. However, another output user may make a request for this file later. The CPU 61 thus terminates use mode determining processing without appending additional information concerning the use mode. In this case, it is judged in step S30 in FIG. 11 that the use mode for the file is not identified after use mode determining processing.

In this manner, the CPU 61 identifies the use mode for a requested file by referring to the use mode field of the file management information concerning the requested file and also referring to the record information concerning the requested file.

In this exemplary embodiment, use mode determining processing is executed before record information concerning the requested file is added in step S90 of FIG. 11. At a time point at which use mode determining processing is executed, record information concerning the received request is not yet added. Accordingly, even if the extracted record information concerning the received request indicates that only the single device ID is described, the device ID described in the received request may be different from that in the extracted record information. In this case, the CPU 61 may check the device ID described in the received request, and if this device ID is different from that in the extracted record information, the CPU 61 may determine in step S120 that multiple device IDs are described in the extracted record information. Alternatively, step S90 in FIG. 11 may be executed before use mode determining processing.

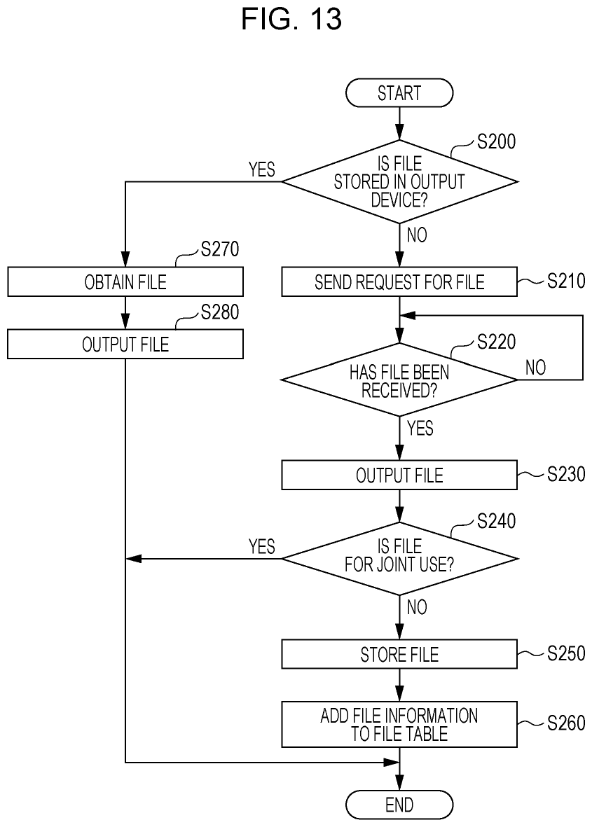

The operation of the output device 30 will now be described below. FIG. 13 is a flowchart illustrating an example of file output processing executed by the CPU 71 upon receiving a request to output a file together with identification information concerning this file from an output user. The information processing program which defines file output processing is stored in advance in the ROM 72 of the output device 30, for example. The CPU 71 of the output device 30 reads the information processing program from the ROM 72 and executes file output processing.

In step S200, the CPU 71 refers to the file table 8 to judge whether the requested file associated with the identification information is stored in the non-volatile memory 74 of the output device 30. If file information indicating the received identification information is stored in the file table 8, it means that the requested file is stored in the non-volatile memory 74. The process then proceeds to step S270.

In step S270, the CPU 71 reads the requested file from the non-volatile memory 74 based on the storage information in the file information.

In step S280, the CPU 71 outputs the requested file to the output user as a result of the image represented by the file obtained in step S270 being printed on a recording medium. The CPU 71 then completes file output processing in FIG. 13.

If it is found in step S200 that the requested file associated with the identification information is not stored in the non-volatile memory 74 of the output device 30, the process proceeds to step S210.

In this case, the requested file is stored in the file management device 20. In step S210, the CPU 71 sends a request for the file associated with the identification information received from the output user. If the output user has specified the use mode of the requested file, the CPU 71 may include the use mode in the request. In this case, the use mode will be identified in use mode determining processing in FIG. 12.

Upon receiving the request from the output device 30, the file management device 20 sends the requested file associated with the identification information indicated in the request, as discussed in distribution processing in FIG. 11.

In step S220, the CPU 71 judges whether the requested file is received from the file management device 20. If the requested file is not received, the CPU 71 repeats step S220 to monitor the reception of the requested file. If the requested file is received, the process proceeds to step S230.

In step S230, as in step S280, the CPU 71 outputs the requested file to the output user as a result of the image represented by the received file being printed on a recording medium.

In step S240, the CPU 71 checks for additional information appended with the received file and judges whether the received file is for joint use. If the received file is not for joint use, the process proceeds to step S250.

If the file is not for joint use, it may be for personal use or the use mode of this file may not have been set after executing use mode determining processing. If the file is found to be for personal use, the use mode of this file can be determined as the personal use mode. If the use mode of the file is not identified, however, it is still possible that the file is for joint use. It is assumed, however, that the file is for personal use if the joint use mode is not set in the file.

In step S250, the CPU 71 stores the received file in the non-volatile memory 74 of the output device 30. When storing the received file in the non-volatile memory 74, the CPU 71 may encrypt the file so that the content of the file will not be reproduced even if it leaks to the outside the output device 30.

In step S260, the CPU 71 generates file information by including the identification information concerning the file and storage information indicating the storage location of the file, and adds the generated file information to the file table 8 so as to record that the requested file is stored in the output device 30. The CPU 71 then completes file output processing in FIG. 13.

In the file management system 1, when a file for personal use is requested from an output device 30 for the first time, it is stored in this output device 30 instead of in the file management device 20. To make a request for the file again, it is highly likely that the request will be made from the same output device 30. It is thus not necessary that the output device 30 obtain the file from the file management device 20.

In the file management system 1, when a file for joint use is requested from an output device 30, it is stored in the file management device 20 instead of in the output device 30.

In the file management system 1, if a file whose use mode is unknown is requested from an output device 30, it is stored both in the file management device 20 and the output device 30. If an output user outputs this file by inputting its use mode into the output device 30 later or if the file management device 20 receives a request for the file from another output device 30 later, the use mode of this file is determined. Then, the storage location of the file is switched in accordance with the identified use mode.

As discussed above, the effective period of a file is managed by the file management device 20. The output device 30 does not have to pay attention to when a file expires. Upon receiving a file deletion request from the file management device 20, the output device 30 deletes a file specified in the request. As a result, an expired file can be deleted in the output device 30.

The output device 30 may alternatively monitor the effective periods of files and voluntarily delete an expired file. In this case, the file management device 20 adds an effective period to a file to be sent to the output device 30. The output device 30 associates the effective period added to the file with file information concerning this file, and manages the expiration date by using the file management DB 38B.

When the file management device 20 sends a requested file to an output device 30 in step S50 or S80 in distribution processing in FIG. 11, it may also send the file to a different output device 30. Upon receiving the file, the different output device 30 stores the file in its non-volatile memory 74. The output device 30 also generates file information by including identification information concerning this file and storage information indicating the storage location of the file, and adds the generated file information to the file table 8 so as to record that the received file is stored in this output device 30.

If the same file is stored in plural output devices 30, it can be restored even if it is inadvertently deleted from the file management device 20 and the output device 30 that has requested the file when the storage location is switched from the file management device 20 to the output device 30 or vice versa.

In this manner, if a file is sent to another output device 30 for a backup other than the output device 30 having requested this file, it is desirable to send the file to an output device 30 having a larger space in the non-volatile memory 74.

The file management device 20 thus obtains information concerning the space of the non-volatile memory 74 of each output device 30 at predetermined regular intervals, and selects one of the output devices 30 having a predetermined space or larger as an output device 30 for a backup. In this case, it is desirable that the file management device 20 sends a backup file to the output device 30 having the largest space.

The predetermined space is a minimal space that allows an output device 30 to operate properly, for example. The predetermined space is determined by experiments using an actual output device 30 or computer simulations.

Only one backup file is sufficient. The file management device 20 thus sends the same file only to one more output device 30 other than the output device 30 that has requested this file.

Concerning the storage of a file, if the use mode of a requested file is unknown after the file management device 20 has received a request for this file from an output device 30 and executed use mode determining processing, the file is stored both in the file management device 20 and the output device 30. However, even if the use mode of a file is not identified after use mode determining processing, information which leads to identifying the use mode may be obtained over time. The file management device 20 thus tries to determine the use mode of a file even before it receives a request for this file from an output device 30.

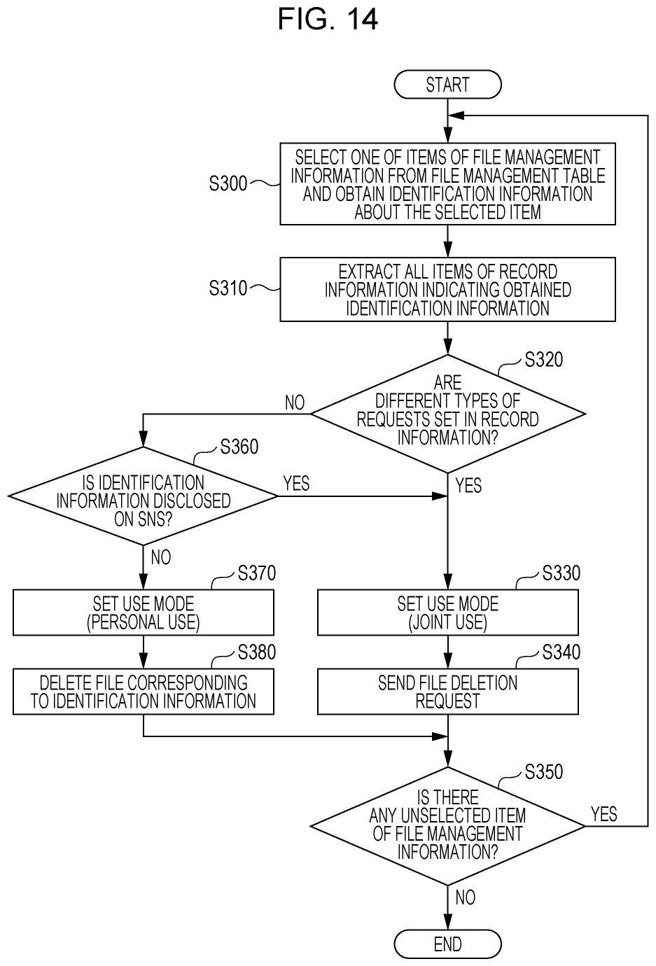

FIG. 14 is a flowchart illustrating an example of regular processing executed by the CPU 61 of the file management device 20 at predetermined regular intervals. The file management program which defines regular processing is stored in advance in the ROM 62 of the file management device 20, for example. The CPU 61 of the file management device 20 reads the file management program from the ROM 62 and executes regular processing.

In step S300, the CPU 61 selects from the file management table 4 one of the unselected items of file management information whose use modes have not yet been determined. The CPU 61 then obtains identification information about the selected item of file management information.

In step S310, the CPU 61 extracts from the record table 6 all items of record information indicating the identification information obtained in step S300.

In step S320, the CPU 61 checks the items of record information extracted in step S310 and judges whether different types of requests corresponding to different operations are set in the request content fields of the items of record information. For example, if “output” and “query” are set in the request content fields, it means that different types of requests are made.

If a file is for personal use, an output user already knows the content of the file and only makes a request to output the file without querying about the content. That is, if multiple types of requests are set in the request content fields of the items of record information, it can be assumed that multiple output users have operated their output devices 30 to output the file.

If it is found in step S320 that different types of requests are set in the request content fields, the process proceeds to step S330. In step S330, the CPU 61 sets “joint use” in the use mode field of the selected item of file management information.

If the use mode of a file is still unknown even after executing use mode determining processing and is then identified as the joint use mode as a result of executing regular processing, it means that the file is also stored in the output device 30 that has requested the file for the first time. It is not however necessary that a file for joint use be stored in the output device 30 if it is stored in the file management device 20. Storing the file in the output device 30 is a waste of the space of the non-volatile memory 74 of the output device 30.

In step S340, the CPU 61 refers to the storage information field of the selected item of file management information. If the file set to be for joint use in step S330 is also stored in the output device 30, the CPU 61 sends a file deletion request including the identification information concerning this file to the output device 30 to instruct it to delete the file.

Then, the CPU 61 erases information indicating the storage location of the file in this output device 30 from the storage information field of the selected item of file management information. That is, in the storage information field of the selected item of file management information, the storage location only in the file management device 20 is stored.

In step S350, the CPU 61 checks whether an unselected item of file management information is left in the file management table 4. If an unselected item of file management information is left, the process returns to step S300. The CPU 61 judges in step S320 for each item of file management information whether different types of requests are set in the request content fields of the items of record information until all the unselected items of file management information whose use modes have not yet been determined are selected from the file management table 4.

If it is found in step S320 that only the same type of request is set in the request content fields of the items of record information, the process proceeds to step S360.

In step S360, the CPU 61 judges via the communication network 2 whether the identification information in the selected item of file management information is disclosed on an SNS. If the identification information is disclosed on an SNS, it means that the file associated with the identification information corresponding to the selected item of file management information is for joint use. The process then proceeds to step S330 in which the CPU 61 sets “joint use” in the use mode field of the selected item of file management information.

If it is found in step S360 that the identification information concerning the file is not disclosed on an SNS, different types of requests concerning this file have not been made and this file has not been requested from plural output devices 30. Based on this situation, it can be assumed that this file is for personal use.

If the identification information in the selected item of file management information is not disclosed on an SNS, the process proceeds to step S370. In step S370, the CPU 61 sets “personal use” in the use mode field of the selected item of file management information.

It is desirable that a file for personal use is stored in the output device 30 that has requested this file for the first time rather than in the file management device 20. Accordingly, in step S380, the CPU 61 refers to the storage information field of the selected item of file management information. If the file set to be for personal use in step S370 is also stored in the output device 30, the CPU 61 deletes this file from the file DB 28A of the file management device 20. Then, the CPU 61 erases information indicating the storage location of the deleted file in the file management device 20 from the storage information field of the selected item of file management information. That is, in the storage information field of the selected item of file management information, the storage location only in the output device 30 is stored. The process then proceeds to step S350.

If it is found in step S350 that all the unselected items of file management information whose use modes have not yet been determined have been selected from the file management table 4, the CPU 61 completes regular processing in FIG. 14.

In step S360, the CPU 61 judges whether identification information is disclosed on an SNS. It is however possible that the identification information be disclosed on another network service, such as a blog. The CPU 61 thus may conduct a search whether the identification information is described on any of the websites by using an existing search engine.

Even if a file for joint use is mistaken for a file for personal use as a result of executing regular processing, the storage location of the file in an output device 30 storing this file is described in the storage information field of the file management information. The file management device 20 thus obtains the file from this output device 30 based on the storage information and sends the file to another output device 30 that has requested this file. Then, the file management device 20 stores the file in the file DB 28A and also sends a file deletion request including the identification information concerning this file to the output device 30 from which the file management device 20 has obtained the file so as to instruct the output device 30 to delete the file. The file management device 20 then updates the storage information in the file management information concerning this file in accordance with the current storage location of the file.

In this manner, in the file management system 1 according to this exemplary embodiment, the use mode of a file requested by an output device 30 is identified. If the file is for personal use, it is stored in this output device 30. If the file is for joint use, it is stored in the file management device 20.

A file for personal use is stored in an output device 30. It is thus possible to reduce the storage amount of files in the file management device 20 compared with a configuration in which all flies are stored in the file management device 20.

A modified example of the exemplary embodiment will be described below.

Use mode determining processing is executed in step S20 in distribution processing by the file management device 20 shown in FIG. 11. As seen from the timing of the execution of use mode determining processing, the file management device 20 identifies the use mode of a file at a timing at which a request for the file is received from an output device 30. The file management device 20 then performs control to switch the storage location of the file in accordance with the identified use mode so that the file can be stored in at least one of the file management device 20 and the output device 30.

However, it may not still be possible to identify the use mode of a file at a time point at which a request for the file is received. Hence, when a request for a file is received from an output device 30, the file management device 20 may provisionally determine that the file is for personal use and send the file to the output device 30. Then, before the effective period of the file elapses, the file management device 20 deletes this file from the DB 28A.

That is, in this modified example, when a request for a file is received from an output device 30, the file management device 20 provisionally stores the file in the output device 30. Then, the file management device 20 identifies the use mode of the file according to whether another request for the file is received and as a result of executing regular processing, and stores the file in a storage location in accordance with the identified use mode.

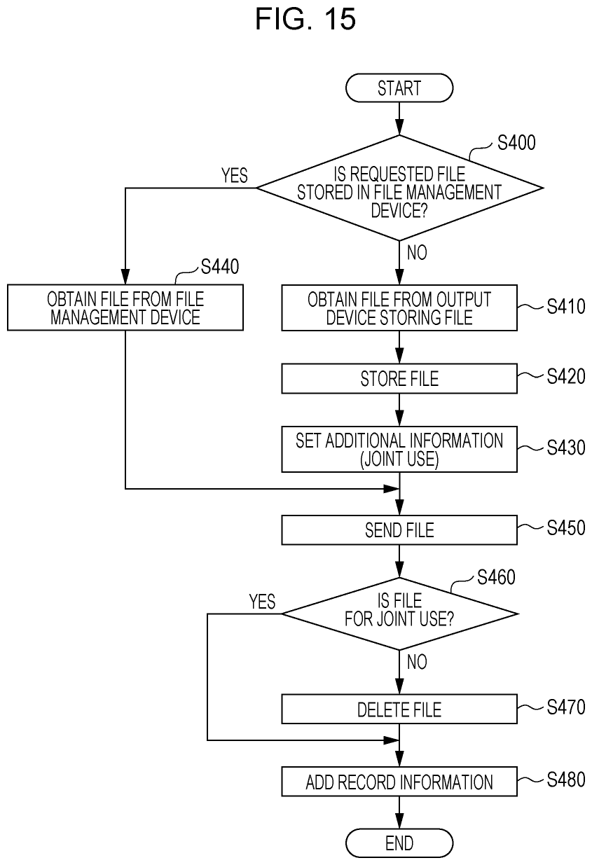

The operation of the file management device 20 according to the modified example will be described below in detail. FIG. 15 is a flowchart illustrating an example of distribution processing executed by the CPU 61 of the file management device 20 upon receiving a request for a file from an output device 30.

In step S400, the CPU 61 refers to the storage information field of file management information concerning the received file associated with identification information indicated in the request, and judges whether the requested file is stored in the file DB 28A of the file management device 20.

If the requested file is stored in the file management device 20, the process proceeds to step S440. If the requested file is stored in the file management device 20, it means that the request for the file received from the output device 30 is the first request for the file.

In step S440, the CPU 61 sets “personal use” in the use mode field of the file management information concerning the requested file, and also writes the URL of the output device 30 in the storage information field.

Then, in step S450, the CPU 61 sends the requested file to the output device 30, together with additional information indicating that the file is for personal use. The CPU 61 then increments the number of output times by one in the file management information concerning the requested file.

As discussed above, in the case of a file for personal use, the CPU 61 may also send the file to another output device 30 for a backup. In this case, the file management device 20 obtains information concerning the space of the non-volatile memory 74 of each output device 30 at predetermined regular intervals, and selects one of the output devices 30 having a predetermined space or larger as an output device 30 for a backup.

In step S460, the CPU 61 judges whether the requested file is for joint use. If the requested file is stored in the file management device 20, it is provisionally handled as a file for personal use, as seen from step S440 in which the CPU 61 has set “personal use” as the use mode. The CPU 61 judges in step S460 that the requested file is not for joint use. The process then proceeds to step S470.

In step S470, since the requested file is for personal use, the CPU 61 deletes the file from the DB 28A.

In step S480, as a result of executing processing similar to step S90 in FIG. 11, the CPU 61 adds record information concerning the request to the record table 6. The CPU 61 then completes distribution processing in FIG. 15.

According to the above-described processing, when a file stored in the file management device 20 is requested from an output device 30 for the first time, it is stored in the output device 30.

After having sent a file to the output device 30 in this manner, the file management device 20 may receive a request for this file from another output device 30.

In this case, it is found in step S400 that the requested file is not stored in the file management device 20, and the process proceeds to step S410.

In step S410, the CPU 61 refers to the storage information field of the file management information concerning the requested file and obtains the requested file from the output device 30 indicated by the storage information.

In the output device 30 from which the file management device 20 has obtained the file, file information concerning this file is deleted from the file table 8, and also, the file is deleted from the file DB 38A.

In step S420, the CPU 61 stores the requested file obtained in step S410 in the file DB 28A. The CPU 61 also accordingly records the storage location of the requested file in the file DB 28A in the storage information field of the file management information concerning the file.

When an output user makes a request for a file for personal use for the second time or thereafter, it is highly likely that the output user uses the same output device 30 as that used in the first request. In this case, as discussed in file output processing executed by the output device 30 shown in FIG. 13, the output device 30 does not request the file management device 20 to send the file because the file is already stored in the output device 30.

That is, if a file which is not stored in the file management device 20 is requested from an output device 30, the request has been made from another output device 30 other than the output device 30 having requested this file for the first time.

In step S430, the CPU 61 sets “joint use” in the use mode field of the file management information concerning the requested file, and also appends additional information indicating that the file is for joint use to the file.

In step S450, the CPU 61 sends the requested file appended with the additional information to the output device 30 which has requested the file.

As discussed in file output processing executed by the output device 30 shown in FIG. 13, the output device 30 receives the file and does not store the file in the output device 30 since the additional information indicates that the file is for joint use.

As discussed above, in step S460, the CPU 61 judges whether the requested file is for joint use. When a file which is not stored in the file management device 20 is requested from an output device 30, “joint use” is set in the use mode field of the file management information concerning this file. The CPU 61 thus determines that the file is for joint use.

The process then proceeds to step S480 by skipping step S470. In step S480, as a result of executing processing similar to step S90 in FIG. 11, the CPU 61 adds record information concerning the request to the record table 6. The CPU 61 then completes distribution processing in FIG. 15. As a result of skipping step S470, the requested file obtained from the output device 30 is stored in the file management device 20.

According to this modified example, if a file requested by an output device 30 is stored in the file management device 20, this request is the first request for the file, and the file management device 20 assumes that this file is for personal use. The file management device 20 then determines the use mode of the file according to whether another request for this file is received. However, as discussed above, information which leads to identifying the use mode may be obtained over time. Hence, in this modified example, as well as in the exemplary embodiment, the file management device 20 tries to determine the use mode even before it receives a request for the file from an output device 30.

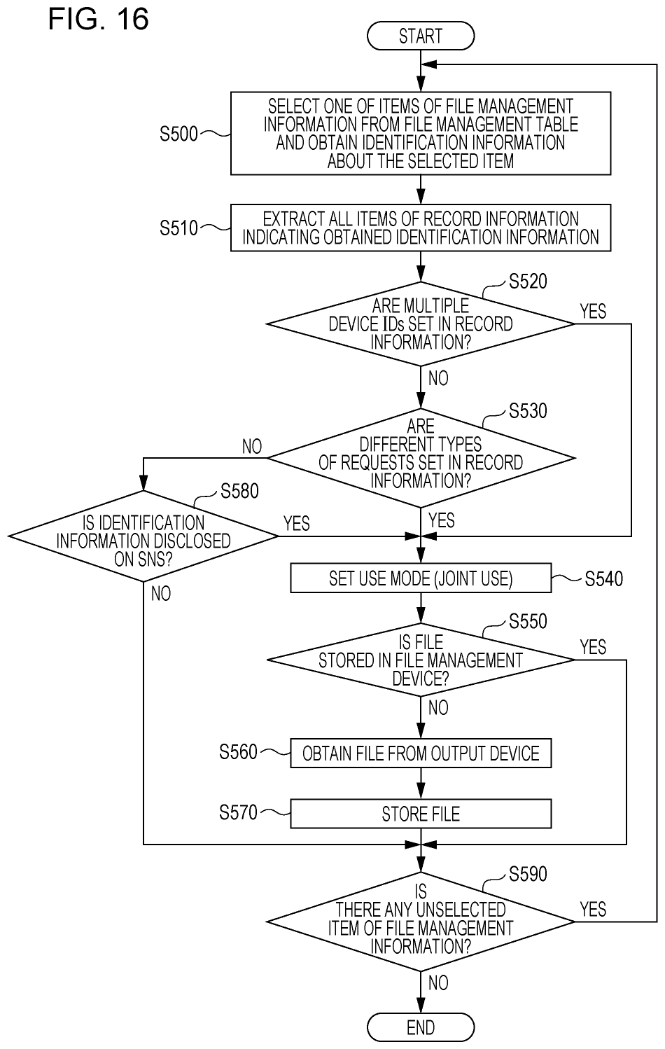

FIG. 16 is a flowchart illustrating an example of regular processing executed by the CPU 61 of the file management device 20 at predetermined regular intervals.

In step S500, the CPU 61 selects from the file management table 4 one of the unselected items of file management information whose use modes have not yet been determined. The CPU 61 then obtains identification information about the selected item of file management information.

In step S510, the CPU 61 extracts from the record table 6 all items of record information indicating the identification information obtained in step S500.

In step S520, the CPU 61 checks the items of record information extracted in step S510 and judges whether multiple device IDs are described in the device ID fields of the items of record information. If multiple device IDs are not described, the process proceeds to step S530.

Even if multiple device IDs are not recorded in the extracted items of record information at a time point at which step S520 is executed, multiple device IDs may possibly be recorded later. Accordingly, it is not desirable to determine that the file is for personal use merely from the result of step S520 in which only the single device ID is described in the extracted items of record information.

In step S530, the CPU 61 checks the items of record information extracted in step S510 and judges whether different types of requests corresponding to different operations are set in the request content fields of the items of record information.

If different types of requests are set in the request content fields of the items of record information, it can be assumed that the file corresponding to the selected item of file management information is for joint use. The process then proceeds to step S540.

If it is found in step S520 that multiple device IDs are described in the device ID fields of the items of record information, it can be assumed only from the judging result of step S520 that the file concerning the selected item of file management information is for joint use. The process then proceeds to step S540 by skipping step S530.

In step S540, the CPU 61 sets “joint use” in the use mode field of the selected item of file management information.

In step S550, the CPU 61 refers to the storage information field of the selected item of file management information and judges whether the file corresponding to the selected item of file management information is stored in the file DB 28A of the file management device 20.

If the file is not stored in the file management device 20, it means that, although the file is for joint use, it has provisionally been determined to be for personal use when the first request for the file has been received and is currently stored in the storage device 30. The process then proceeds to step S560.

In step S560, the CPU 61 refers to the storage information field of the selected item of file management information and obtains the file from the output device 30 indicated in the storage information field. As discussed above, in the output device 30 from which the file management device 20 has obtained the file, file information concerning this file is deleted from the file table 8, and also, the file is deleted from the file DB 38A.

In step S570, the CPU 61 stores the file obtained in step S560 in the file DB 28A. The CPU 61 also accordingly records the storage location of the file in the file DB 28A in the storage information field of the selected item of file management information. The process then proceeds to step S590.

If it is found in step S550 that the file corresponding to the selected item of file management information is stored in the file management device 20, it is not necessary to obtain the file from the output device 30. The process thus proceeds to step S590 by skipping steps 5560 and 5570.

If it is found in step S530 that only the same type of request is set in the request content fields of the items of record information, the process proceeds to step S580.

Even if only the same type of request is set in the request content fields of the items of record information at a time point at which step S530 is executed, multiple types of requests may possibly be recorded later. Accordingly, it is not desirable to determine that the file is for personal use merely from the result of step S530 in which only the same type of request is described in the extracted items of record information.

In step S580, the CPU 61 judges via the communication network 2 whether the identification information described in the selected item of file management information is disclosed on an SNS.

As discussed above, if the identification information is disclosed on an SNS, it means that the file associated with the identification information corresponding to the selected item of file management information is for joint use. The process then proceeds to step S540 in which the CPU 61 sets “joint use” in the use mode field of the selected item of file management information.

If it is found in step S580 that the identification information concerning the file is not disclosed on an SNS, it means that different types of requests concerning this file have not been made and this file has not been requested by plural output devices 30. Based on this situation, it can be assumed that this file is for personal use. The process then proceeds to step S590.

In step S590, the CPU 61 checks whether an unselected item of file management information is left in the file management table 4. If an unselected item of file management information is left, the process returns to step S500. The CPU 61 executes steps 5500 through 5590 until all the unselected items of file management information whose use modes have not yet been determined are selected from the file management table 4.

If it is found in step S590 that all the unselected items of file management information whose use modes have not yet been determined have been selected from the file management table 4, the CPU 61 completes regular processing in FIG. 16.

In the file management system 1 according to this modified example, a file requested by an output device 30 is provisionally stored in the output device 30 instead of in the file management device 20. Then, based on the determining result of the use mode of the file, the storage location of the file is changed if necessary.

A file requested by an output device 30 is stored in the output device 30 until the use mode of the file is determined as a result of executing regular processing. It is thus possible to reduce the storage amount of files in the file management device 20 compared with a configuration in which, every time a file is received, the use mode of the file is identified, and only when the file is determined to be for personal use, is it deleted from the file management device 20.

The present disclosure has been discussed through illustration of the exemplary embodiment. However, the disclosure is not restricted to the technical range of the above-described exemplary embodiment. Various modifications and/or improvements may be made to the exemplary embodiment without departing from the spirit and scope of the disclosure. Exemplary embodiments obtained by making modifications and/or improvements are also encompassed within the technical range of the disclosure. For example, the order of operations may be changed without departing from the spirit and scope of the disclosure.

In the above-described exemplary embodiment, the processing operations are implemented by software by way of example. However, operations equivalent to those shown in the flowcharts of FIGS. 11 through 16 may be implemented by using hardware, such as an application specific integrated circuit (ASIC). In this case, operations are executed faster than those implemented by software.

Although the programs are installed in the corresponding ROMs in the above-described exemplary embodiment, they may be provided in a different manner. For example, the programs may be provided as a result of being recorded in a computer-readable storage medium, for example, in an optical disc, such as a compact disc (CD)-ROM or a digital versatile disc (DVD)-ROM, or in a semiconductor memory, such as a universal serial bus (USB) memory or a flash memory.

The file management device 20 and the output device 30 may obtain the programs via the communication network 2 from an external device connected to the communication network 2.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A file management device comprising:
a controller that performs control to obtain a file requested by a first information processing device from a file storage and to send the requested file to the first information processing device and that performs control to determine whether to delete the requested file from the file storage before an effective period of the requested file elapses, the first information processing device storing a received file in a storage and providing the file to a user.

2. The file management device according to claim 1, further comprising:
a determiner that determines whether a use mode of the requested file is a personal use mode or a joint use mode, the personal use mode being a mode in which the requested file is used by an individual user, the joint use mode being a mode in which the requested file is used by a plurality of users,
wherein, if the determiner has determined that the use mode of the requested file is the personal use mode, the controller performs control to delete the requested file from the file storage, and if the determiner has determined that the use mode of the requested file is the joint use mode, the controller performs control to cause the first information processing device to delete the requested file from the storage.

3. The file management device according to claim 1, further comprising:
a determiner that determines whether a use mode of the requested file is a personal use mode or a joint use mode, the personal use mode being a mode in which the requested file is used by an individual user, the joint use mode being a mode in which the requested file is used by a plurality of users,
wherein, if the controller has performed control to delete the requested file from the file storage before the effective period of the requested file elapses and if the determiner has determined that the use mode of the requested file is the joint use mode, the controller performs control to obtain the requested file from the first information processing device and stores the requested file in the file storage.

4. The file management device according to claim 2, wherein the determiner determines the use mode of the requested file by referring to a use mode which is set in the requested file in advance by a register user having registered the requested file in the file storage.

5. The file management device according to claim 4, wherein, when the requested file is requested for the first time, the determiner determines the use mode of the requested file by referring to the use mode which is set in the requested file in advance by the register user having registered the requested file in the file storage.

6. The file management device according to claim 2, wherein the determiner determines the use mode of the requested file in accordance with a use mode of the requested file supplied from the first information processing device.

7. The file management device according to claim 2, wherein the determiner determines the use mode of the requested file by referring to record information concerning the requested file, the record information indicating a request record for the requested file including an operation record for the requested file.

8. The file management device according to claim 3, wherein the determiner determines the use mode of the requested file by referring to record information concerning the requested file, the record information indicating a request record for the requested file including an operation record for the requested file.

9. The file management device according to claim 7, wherein, if the record information concerning the requested file indicates that the requested file has been requested from another information processing device other than the first information processing device, the determiner determines that the use mode of the requested file is the joint use mode, and if the record information indicates that the requested file has been requested only from the first information processing device, the determiner determines that the use mode of the requested file is the personal use mode.

10. The file management device according to claim 7, wherein, if the operation record described in the record information indicates that a type of operation different from a type of operation performed to request the requested file for the first time has been performed, the determiner determines that the use mode of the requested file is the joint use mode, and if the operation record indicates that only the same type of operation performed to request the requested file for the first time has been performed, the determiner determines that the use mode of the requested file is the personal use mode.

11. The file management device according to claim 10, wherein the determiner refers to the operation record at predetermined regular intervals.

12. The file management device according to claim 2, wherein the determiner determines the use mode of the requested file by referring to content described on a website.

13. The file management device according to claim 3, wherein the determiner determines the use mode of the requested file by referring to content described on a website.

14. The file management device according to claim 12, wherein, if identification information used for making a request for the requested file received from the first information processing device is disclosed on a website, the determiner determines that the use mode of the requested file is the joint use mode, and if the identification information is not disclosed on a website, the determiner determines that the use mode of the requested file is the personal use mode.

15. The file management device according to claim 14, wherein the determiner checks whether the identification information is disclosed on a website at predetermined regular intervals.

16. The file management device according to claim 1, wherein, if a request for the requested file is received from a different information processing device other than the first information processing device after the requested file is deleted from the file storage, the controller performs control to obtain the requested file from the first information processing device and sends the requested file to the different information processing device.

17. The file management device according to claim 16, wherein the controller performs control to store the requested file obtained from the first information processing device in the file storage and to cause the first information processing device to delete the requested file from the storage of the first information processing device.

18. The file management device according to claim 1, wherein the controller performs control to send the requested file to a different information processing device other than the first information processing device and to cause each of the first information processing device and the different information processing device to store the requested file in the storage.

19. The file management device according to claim 18, further comprising:
an acquirer that acquires information concerning a space of the storage,
wherein the controller performs control to select the different information processing device from among information processing devices that are found to have a predetermined space or larger in the storages based on the information acquired by the acquirer.

20. A non-transitory computer readable medium storing a program causing a computer to execute a process, the process comprising:
performing control to obtain a file requested by a first information processing device from a file storage and to send the requested file to the first information processing device and performing control to determine whether to delete the requested file from the file storage before an effective period of the requested file elapses, the first information processing device storing a received file in a storage and providing the file to a user.
